(19) United States
(12) Patent Application Publication
(10) Pub. No.: US 2010/0090412 A1
(43) Pub. Date: Apr. 15, 2010

(54) CARTRIDGE SEAL

(76) Inventors: Thomas M. Scott, Lucas, OH (US); Craig Redmond, Lexington, OH (US); David Meister, Mansfield, OH (US)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 12/445,094

(22) PCT Filed: Oct. 12, 2006
(86) PCT No.: PCT/US06/40163

§ 371 Date: Apr. 10, 2009

(51) Int. Cl. F16J 15/34

(52) U.S. Cl. 277/375

(57) ABSTRACT

A seal cartridge for providing a fluid seal between a rotating shaft and a housing such as found in a centrifugal pump. The seal cartridge includes rotating and non-rotating seal portions. The non-rotating seal portion includes a seal ring seat that is connected to the support sleeve by a frangible element. During installation, the frangible element is separated to release the non-rotating portion of the seal from the support member. The non-rotation seal portion includes an O-ring held by a stationary seal holder. An O-ring seal seals a circumferential periphery of the seal ring to inhibit fluid leakage between the holder and the seal ring. An inside radial end face of the seal ring abuttingly engages a radial end face defined by the holder which enhances heat transfer between the seal ring and the holder. A plurality of grooves or recesses are formed in either the inside end face of the seal ring or the radial end face of the holder and are arranged to receive cooling fluid from the pump housing to further promote cooling of the seal.

### TECHNICAL FIELD

The present invention relates generally to rotary, mechanical shaft seals and in particular to an improved cartridge seal.

### BACKGROUND ART

Pumps and similar equipment which include rotating shafts have been provided with seals of various types to prevent leakage along their shafts. One conventional type of seal is known as a face seal and typically comprises a rotating portion fixed to the shaft defining a radial sealing face and a fixed portion secured to the housing also defining a radial sealing face, the two sealing faces disposed in abutting, sealing contact. Normally, the seal faces are maintained in engagement by a spring forming part of the seal assembly.

Examples of this type of seal can be found in U.S. Pat. No. 3,447,810 and U.S. Pat. No. 4,342,538, both owned by the assignee of the present application.

U.S. Pat. No. 4,815,747 discloses a cartridge form of a pump seal that is used to seal the pump shaft of a centrifugal pump. All the seals disclosed in the above-referenced U.S. patents, include non-rotating seal sections mounted in a pump cavity and a rotating seal section mounted to the shaft. The rotating seal section includes a coil spring surrounding the shaft for spring loading a rotating seal ring towards engagement with a non-rotating seal ring forming part of the fixed seal section. Both seal rings define radial faces which during pump operation sealingly engage.

In the seal construction disclosed in the '810 and '538 patents, the rotating and non-rotating seal sections are separately installed into the pump. In the '747 patent, the non-rotating and rotating seal sections are in a cartridge form prior to installation. During installation, a frangible element separates so that the rotating section can rotate with a pump shaft whereas the non-rotating section is fixed to the pump housing. The cartridge seal disclosed in the '747 patent has enjoyed great commercial success.

### DISCLOSURE OF THE INVENTION

The present invention provides a new and improved seal cartridge for sealing the interface between a rotating shaft and a stationary housing such as that found in a centrifugal pump. The cartridge seal of the present invention represents an improvement in the cartridge seal disclosed in U.S. Pat. No. 4,815,747, which is hereby incorporated by reference. According to the invention, the seal cartridge is constructed as a unitary assembly having interconnected rotating and non-rotating portions. During installation of the seal cartridge, the coupling between the rotating and non-rotating portions is disconnected or separated so that after installation, the rotating portion is operatively connected to the shaft and the non-rotating portion is fixed to the housing. A rotating, sealing interface is defined between the non-rotating and rotating portions.

To facilitate the explanation of the invention, it will be described in connection with its use in a centrifugal pump. It should be understood, however, that the invention can be used in any application that requires a rotary seal for sealing a shaft/housing interface.

In the preferred embodiment, the seal cartridge includes a support member which prior to installation supports both the non-rotating and rotating portions of the seal. According to the invention, a frangible member couples the non-rotating portion of the seal to the support member.

The rotating seal portion is the same or similar to the rotating seal portion disclosed in the '747 patent. The non-rotating portion of the seal includes a seal holder or seal seat which supports a stationary seal ring. The holder is sealingly received by pump housing structure. In the preferred and illustrated embodiment, a peripheral seal surrounds the stationary seal ring and sealingly engages an axial inside surface of the holder. The O-ring may be carried by a groove in the stationary seal ring located intermediate inside and outside end faces of the seal ring. Alternately, the groove may be an end groove located on the inside face of the seal ring. In still another alternative, the O-ring may be carried by an internal groove formed in the holder or stationary seat.

The non-rotating portion of the seal includes a seal seat or holder which supports the stationary seal ring and which is secured to housing structure. According to a feature of the invention, the stationary seal ring includes an inside end face which confrontingly engages a radial surface or radial face of the stationary holder. The abutting engagement between the seal ring and the holder promotes heat transfer from the seal ring to the holder from where it is transferred to the pump housing. With the present invention, cooling of the seal is promoted resulting in increased seal life.

According to the invention, the seal cartridge is installed into the mechanism i.e. pump, by placing the assembly onto the shaft. The support member is pushed or advanced until the seal seat reaches its installed position. Further advancement of the support member causes the frangible coupling to separate so that the non-rotating portion of the seal is decoupled from the support member enabling the rotating portion to rotate relative to the non-rotating portion.

In the preferred embodiment, the support sleeve is advanced onto the shaft until an end surface abuts a shoulder formed on the shaft. The sleeve is locked or clamped in position by a locking element which locks the support sleeve and hence the rotating portion of the seal to the shaft.

In the disclosed embodiment, the seal cartridge is used to seal the rotating shaft of a centrifugal pump. In this embodiment, the seal is located in a seal cavity defined by a cup-shaped seal plate. The pump shaft includes a threaded end adapted to threadedly receive an impeller. In the preferred installation method, the seal cartridge is placed on the end of the impeller shaft and the impeller is then threaded onto the shaft end. An inner end-face of the impeller abuts an end of the seal cartridge and advances the support sleeve axially along the pump shaft as the impeller is threaded onto the shaft end. The support sleeve is sized such that when fully installed, it is clamped between the inner end-face of the impeller and a shoulder formed on the pump shaft and is rigidly held thereto.

According to additional features of the invention, the stationary seal ring and/or seal ring holder includes a plurality of slots for receiving lubricating fluid from inside the pump housing. The slots may be formed on an inside end face of the seal ring so that when the seal ring abuttingly engages the radial surface on the holder, cooling oil is received in the region where heat transfer between the seal ring and the holder occurs. Alternately, the slots may be formed in the radial heat exchange surface of the holder.

Additional features of the invention will become apparent and a fuller understanding obtained by reading the following detailed description made in connection with the accompanying drawings.

### BRIEF DESCRIPTION OF THE DRAWINGS

The foregoing and other features of the present invention will become apparent to one skilled in the art to which the present invention relates upon consideration of the following description of the invention with reference to the accompanying drawings, wherein:

FIG. 1 is a fragmentary, sectional view of a centrifugal pump showing a seal cartridge, constructed in accordance with a preferred embodiment of the invention, as it appears at the beginning of an installation process;

FIG. 2 is another fragmentary, sectional view of the centrifugal pump showing the seal cartridge as it appears at the completion of the installation process;

FIG. 3 is an exploded view of the cartridge seal constructed in accordance with the preferred embodiment of the invention and a pump shaft;

FIG. 4 is an enlarged, fragmentary sectional view of the cartridge seal shown in FIG. 2;

FIG. 5 is a fragmentary, sectional view of an alternate embodiment of the cartridge seal;

FIG. 6 is a fragmentary, sectional view of another embodiment of the cartridge seal;

FIGS. 7A and 7B illustrate a seal ring construction that includes cooling slots, constructed in accordance with a preferred embodiment of the invention;

FIGS. 8A and 8B illustrate another embodiment showing cooling slots in an alternate seal ring; and

FIGS. 9A and 9B illustrate a seal ring holder constructed in accordance with a preferred embodiment of the invention that includes cooling slots.

### BEST MODE FOR CARRYING OUT THE INVENTION

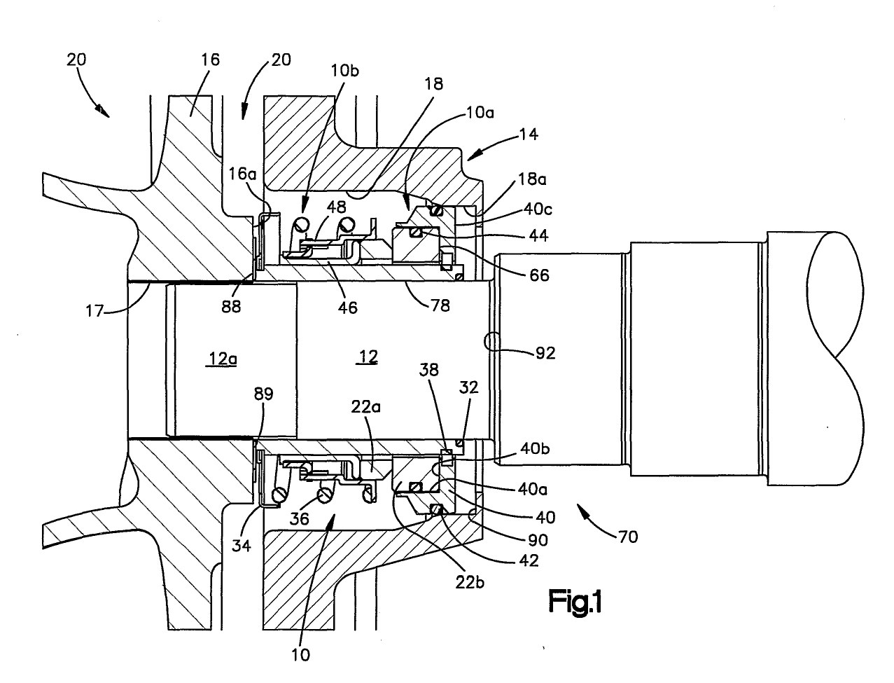

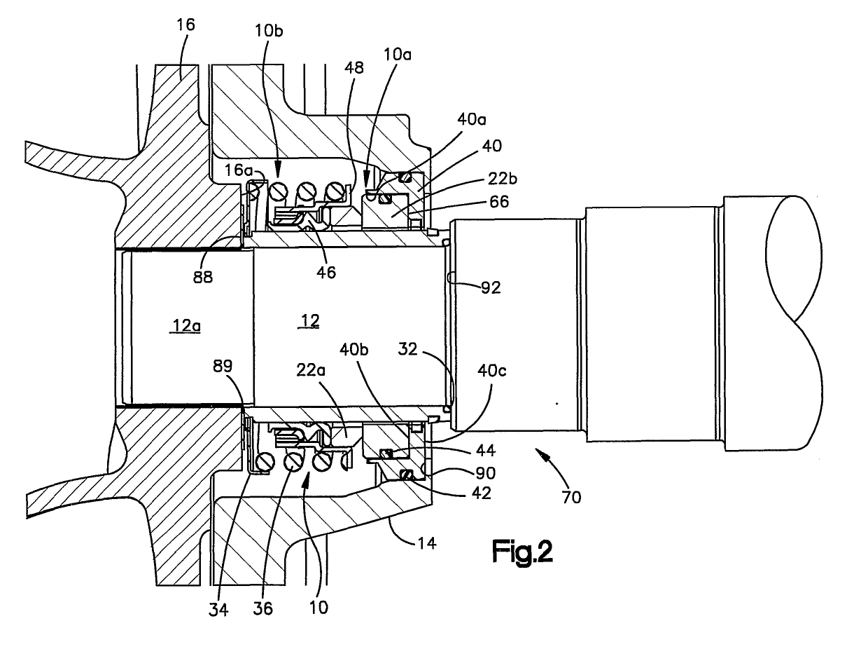

FIGS. 1 and 2 illustrate the overall construction of a seal cartridge 10, constructed in accordance with the preferred embodiment of the invention, shown as it appears at the commencement of an installation process (FIG. 1) and as it appears after the installation process is completed (FIG. 2).

Turning first to FIGS. 1 and 2, the seal cartridge 10 is shown as it would be used in a pump application. In particular, the seal 10 is operative to seal the interface between a pump shaft 12 and a pump housing (a portion of which is indicated generally by the reference character 14) to inhibit fluid leakage along the shaft and into the interior of the housing 14. In the disclosed embodiment, the pump is of the centrifugal type and includes an impeller 16 threadedly mounted to a threaded end 12a of the pump shaft 12. The impeller 16 includes a threaded central bore 17 for receiving the shaft end 12a.

The housing 14 defines a cup-shaped seal cavity 18 including a machined recess 18a which receives a non-rotating portion 10a of the cartridge seal 10. The remainder of the seal cavity 18 shrouds a rotating part 10b of the cartridge seal and at least partially protects seal components from-material being pumped through an impeller chamber (not specifically shown, but indicated generally by the reference character 20.

According to the invention, the seal cartridge 10 is constructed as a unitary assembly with the rotating portion 10b and the non-rotating portion 10a coupled together so that both portions of the seal are installed concurrently during an installation process.

With the illustrated construction, the entire seal 10 including both the rotating and non-rotating portions 10a, 10b are installed concurrently. The alignment of the parts are maintained throughout the installation process.

The present invention represents an improvement over a cartridge seal disclosed in U.S. Pat. No. 4,815,747, owned by the Assignee of the present application, and is hereby incorporated by reference. The seal cartridge disclosed in the '747 patent illustrates and provides additional details regarding a cartridge seal having rotating and non-rotation portions that are coupled together prior to installation so that both portions of the seal are installed concurrently. During the installation process, and as more fully described in the '747 patent, the coupling between the rotating and non-rotating portion is broken.

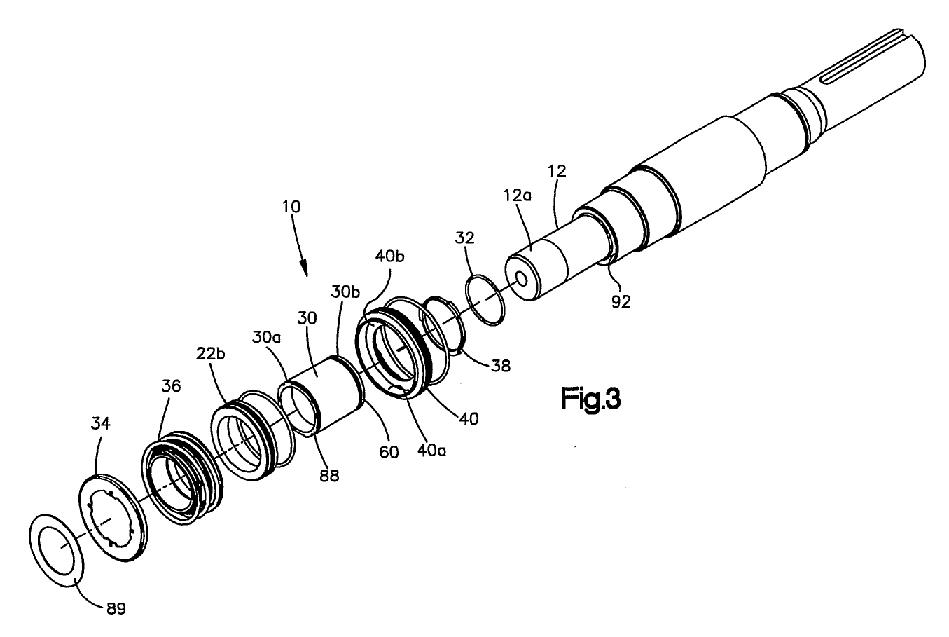

Referring also to FIG. 3, the seal cartridge 10 includes a tubular support member 30 which is adapted to fit around or receive the pump shaft 12. The support member 30 includes an O-ring type seal 32 for inhibiting fluid leakage between itself and the pump shaft 12. A left end 30a of the support member 30 (as viewed in FIG. 1) mounts a centering washer 34 which also serves as a spring seat for a biasing spring 36. A frangible mounting ring 38 is carried near a right end 30b (as view in FIG. 3) of the support member 30 which, at least for a portion of the installation process, rigidly supports a non-rotating seal ring seat or holder 40 which forms part of the non-rotating portion 10a of the cartridge seal 10. The frangible ring 38 causes the seal ring seat or holder 40 to move with the support member 30 as the support member is advanced along the pump shaft 12 i.e. towards the right as viewed in FIG. 1.

The non-rotating seal ring seat 40 includes an O-ring seal 42 which sealing engages the recess 18a to inhibit fluid leakage between itself and the housing 14. The stationary seal ring holder 40 carries a seal ring or face seal element 22b in a way that inhibits relative rotation between itself and the seal ring 22b and also carries an O-ring seal 44 for inhibiting fluid leakage between the seat 40 and the seal ring 22b.

According to the invention, the circumferential, O-ring seal 44, seals the periphery of the seal ring 22b to an inside, axial surface 40a of the holder 40. In the embodiment illustrated in FIG. 1-3, the peripheral O-ring 44 is carried in an O-ring groove defined by the seal ring 22b. A peripheral seal comprising an O-ring carried in an internal groove formed in the holder 40 is also contemplated.

As seen best in FIGS. 1 and 2, according to a feature of the invention, an inside, radial end surface 66 defined by the seal ring 22b directly abuts a radial end surface 40b defined by the holder 40. The abutting engagement between these two surfaces 66, 40b promotes heat transfer from the stationary seal ring 22b and the holder 40 and, in turn, is transferred to the housing 14 for dissipation. It has been found, that with the disclosed construction, the life of the seal rings 22a, 22b are increased since the transfer of heat away from the interface between the non-rotating seal ring 22b and a rotating seal ring or face seal 22a is facilitated.

It should also be noted here that in the illustrated embodiment, the frictional engagement of the O-ring seal 42 with the housing recess 18a and the holder 40 inhibits relative rotation between these components. Similarly, the O-ring seal 44 inhibits relative rotation between the holder 40 and the face seal 22b. Mechanical engagement structure such as splines, lugs, pins, etc. between the holder 40 and the housing 14 and/or the holder 40 and the sealing element 22b are also contemplated by the invention.

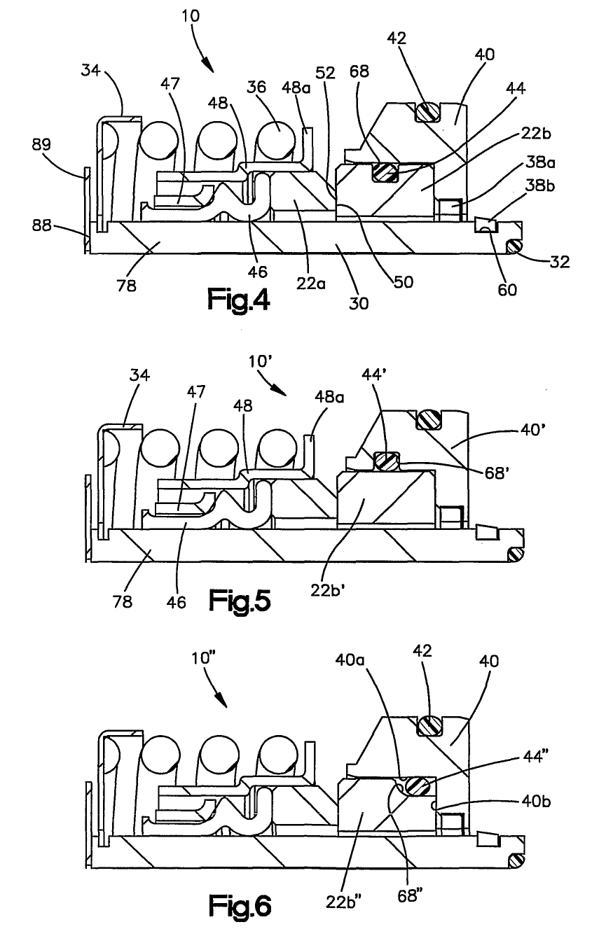

As is conventional, the rotating portion 10b of the seal cartridge 10 includes a bellows member 46 clamped at its left end to the support member 30 (as viewed in FIG. 1) by a drive band 47. Referring also to FIG. 4, the transmission of torque from the drive shaft 12 to the rotating seal ring 22a is achieved as follows. The right end of the bellows 46 is connected to the rotating seal ring 22a and allows the seal ring 22a to move axially towards and away from the stationary seal ring 22b. A conventional cage member 48 supports the seal ring 22a and rotatably couples the ring to the bellow 46 and, hence the support member 30, while allowing axial movement in the seal ring 22a relative to the support member 30. Splines or lugs/lug engaging recesses (not shown) may be formed on the cage (and on the seal ring 22a) to provide the requisite drive coupling between the elements. The drive band 47 includes a plurality of axially extending tabs that are received in associated slots (not shown) formed in the cage 48. The engagement between the slots and the tabs provide a slidable coupling between the cage 48 and the drive band 47 (and hence the bellows 46). The biasing spring 36 acts between the centering washer 34 and a lip 48a of the cage 48 and exerts a biasing force on the seal ring 22a urging a radial face 50 into abutting, sealing contact with a radial face 52 of the seal ring 22b. The elements 47, 46, 48 and the method by which the seal ring 22a is coupled to the drive shaft 12 is considered conventional. Additional details can be found in the '747 patent. As more fully described in U.S. Pat. No. 4,815,747, the drive band or other retaining structure causes the bellows member 46 to frictionally engage the support member 30. The frictional engagement enables the bellows to slide axially along the support member during installation if sufficient force is applied. During pump operation the bellows member 46 grips the support member with a frictional force sufficient to transmit torque to a rotating seal ring or face seal 22a when the shaft 12 rotates.

As indicated above, at the commencement of the installation process, the rotating and non-rotating portions 10b, 10a of the seal cartridge 10 are interconnected so that both portions are installed concurrently. In particular, the stationary seal ring seat 40 is coupled to the support member 30 by the frangible ring-like element 38. For purposes of explanation the element 38 will be termed a “shear ring”. As seen best in FIG. 3, the shear ring 38 is carried by an annular groove 60 formed near the right end 30b of support member 30 (as viewed in FIG. 1). Further details of the shear ring and its function can be found in U.S. Pat. No. 4,814,747.

In the preferred installation method and referring in particular to FIGS. 1 and 2, the cartridge assembly 10 (including cross-coupled rotating and non-rotating portions 10b, 10a) is placed on the pump shaft 12. The bore 78 of the support member 30 is sized to receive the pump shaft 12, preferably with a fairly close fit. The pump impeller 16 is then threaded onto the end 12a of pump shaft 12 which is then used to press the seal cartridge 10 into position. As the pump impeller 16 is threaded onto the pump shaft 12, a radial face 16a engages a radial end face 88 defined by the left end 30a of the support member 30. A shim 89 may be placed between the faces 16a, 88. Rotation of the impeller onto the shaft 12 and pushes the support member 30 towards the right (as viewed in FIG. 1). i.e. towards its installed position (shown in FIG. 2). The shear ring 38 supports the non-rotating seal ring seat and maintains its alignment with the seal cavity recess 18a. In the preferred installation method, the support member 30 is gradually pushed axially along the shaft 12 and carries or drives the seal ring seat 40 into the housing recess 18a.

After the seal ring seat 40 bottoms in the recess 18a i.e. once an outer radial end face 40c of the seat abuts a radial end surface 90 defined by the recess 18a, continued advancement of the support member 30 (by rotating the impeller further onto the pump shaft 12) causes tab portions 38a of the shear ring 38 to separate from an annular band-like portion 38b as seen in FIG. 4. The tabs sever or fracture in the regions of weakness defined by the shear ring. The support member 30 advances axially along the pump shaft 12 until a right end (as viewed in FIG. 2) abuts a shoulder 92 formed on the pump shaft. The frictional engagement between the support member 30 and the bellows 46 forms a torsionally strong bond for transmitting torque from the shaft 12 to the seal ring 22a.

The support member 30 is locked to the pump shaft 12 by virtue of being clamped between the radial face 16a of the impeller 16 and the shoulder 92 on the pump shaft 12. After installation, the non-rotating and rotating portions 10a, 10b of the seal are relatively rotatable. The fluid seal is established by the abutting contact between the radial seal faces 50, 52 defined by the rotating and non-rotating seal rings 22a, 22b, respectively (shown in FIG. 4). With the disclosed invention, a rotary shaft seal on a pump or other mechanism can be easily replaced in the field even in those situations where space or access to the seal region is limited. With the disclosed invention, seal installation is a one step process and eliminates the need for separately installing a fixed, non-rotating seal ring seat into the housing followed by the installation of a rotating seal portion onto the shaft.

FIG. 4 is an enlarged sectional view of the cartridge seal 10 shown in FIGS. 1-3. It should be noted that the O-ring seal 44 is carried in an O-ring groove 68 formed in the non-rotating seal face 22b. The O-ring groove 68 is generally located centrally on the periphery of the seal ring 22b. FIG. 4 also illustrates the condition of the shear ring 38 after installation. As described above, it is a frangible ring that splits into two parts 38a, 38b during installation.

FIG. 5 illustrates an alternative construction for the cartridge seal 10′. In this alternate embodiment, an O-ring 44′ which serves the same purpose as the O-ring 44 shown in FIG. 4, is carried by an O-ring groove 68′ that is formed in the stationary seal holder 40′. The seal 22b′ does not have an O-ring groove.

FIG. 6 illustrates another alternative embodiment. In this embodiment, an O-ring seal 44″ for sealing a seal ring 22b″ to the holder 40 is carried in an end groove 68″ formed in the face seal 22b″. In the preferred embodiment, the axial length of the groove 68″ is wider than the diameter of the O-ring 44″ so that after installation, the O-ring 44″ does not exert an axial force on the holder surface 40b. It only exerts a sealing engagement with the axial surface 40a of the holder 40.

The term “O-ring” used above is intended to serve as a generic description for an annular type seal. This invention is not limited to an “O-ring” having a circular cross section. “O-rings” with rectangular (often termed quad rings), oblong and other cross sections are contemplated by the present invention.

As viewed in FIGS. 1 and 2, the region of the pump indicated generally by the reference character 70 is a bearing housing that is filled with lubrication oil or coolant fluid. As a result, a right end face 40c of the holder 40 is in contact with and is bathed in oil, (including shaft 12). According to the invention, alternate constructions for both the seat 22b and the holder 40 are contemplated to promote further cooling of these components by the lubricating oil in the chamber 70.

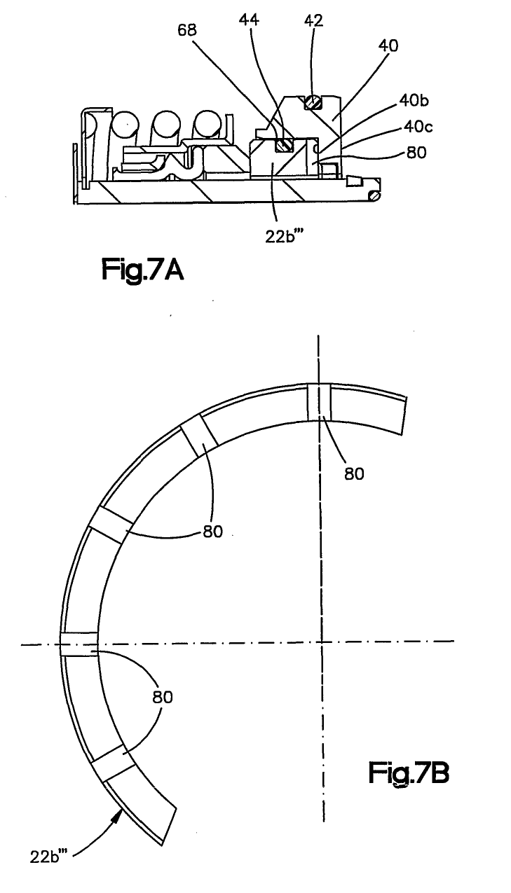

FIGS. 7A and 7B illustrate one alternate embodiment. In this embodiment, the relationship between the stationary face seal 22b″′ and the stationary holder 40 is similar to that shown in FIG. 4, i.e., the O-ring seal 44 is carried in the O-ring groove 68 formed in the seal ring 22b″′. However, in this alternate construction, the seal ring 22b″′ is formed with a plurality of radial cooling slots 80 that receive oil from the pump chamber 70. This lubricating oil communicated between the seal ring 22b″′ and the end face 40b of the holder 40 promote cooling of those components. In addition, the same type of face seal ring 22b″′ with the radial slots 80 can be used with the construction shown in FIG. 5, i.e., with the O-ring seal 44′ carried in an O-ring groove 68′ formed in the holder 40′.

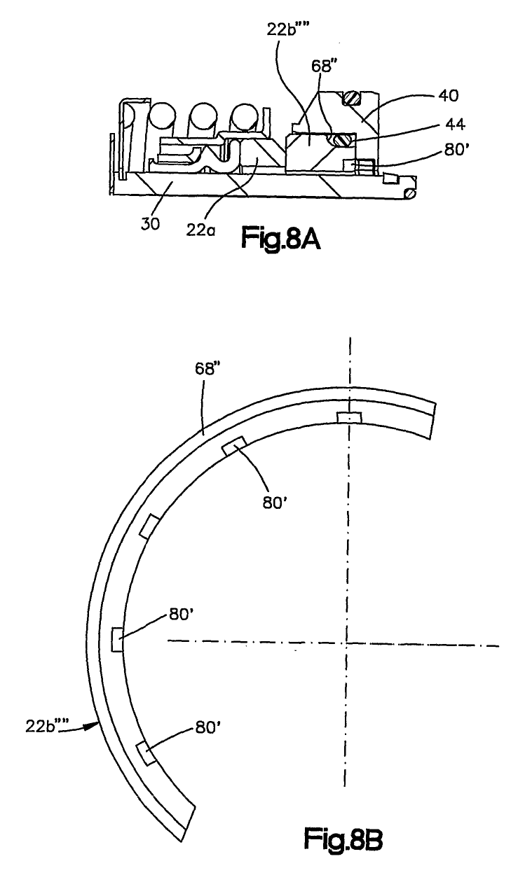

FIGS. 8A and 8B illustrate a method and apparatus for increasing the cooling for the alternate construction shown in FIG. 6. In this alternate construction, a stationary face seal 22b″″ (which includes the end groove 68″ for carrying the O-ring seal 44″) includes a plurality of radial slots 80′ for receiving lubricating oil from the chamber 70. The addition of this lubricating oil to the slot regions promotes cooling of the stationary face seal 22b″″ and the holder 40.

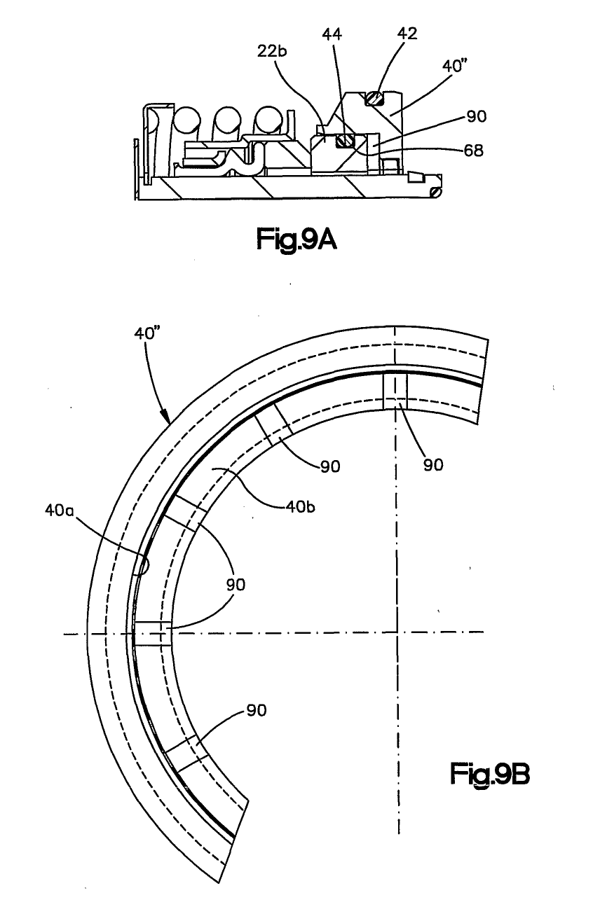

FIGS. 9A and 9B illustrate another alternate construction which includes cooling of seat holder 40″ and face seal 22b. The construction shown in FIGS. 9A, 9B is similar to that shown in FIG. 4 in that the O-ring seal 44 is held in an O-ring groove 68 formed in the face seal 22b. However, in this alternate construction, a modified seal holder 40″ is disclosed which includes a plurality of radial slots 90 formed in the radial endface 40b of the alternate holder 40′. Like the slots 80 shown in FIGS. 8A and 8B, the slots 90 receive lubricating oil or fluid from the pump chamber 70 and promote cooling of the holder 40″ and/or the face seal or seal ring 22b.

The stationary seat 40″ including the radial slots 90 can also be used in the alternate construction shown in FIGS. 5 and 6. However, the radial slots 90 would be reduced in length for the configuration shown in FIG. 6, so that the lubricating oil from the bearing chamber 70 is not communicated to the end groove 68″. In other words, the radial extent of the slots 90 would stop short of the end groove 68″.

Although the invention has been described with a certain degree of particularity, it should be understood that those skilled in the art can make various changes to it without departing from the spirit or scope of the invention as hereinafter claimed.

Having described the invention, we claim the following:

1. A seal cartridge for providing a fluid seal between a rotating shaft and a housing, comprising:
(a) a tubular support member adapted to receive a rotatable shaft;
(b) said support member supporting rotating and non-rotating seal portions, said rotating portion being coupleable to a rotatable shaft and said non-rotating portion being coupleable to a housing;
(c) a frangible support means for supporting said non-rotating seal portion in a predetermined position with respect to said rotating portion, during an installation process; and,
(d) said non-rotating portion including:
(i) a stationary holder defining an inside axial surface and an inside radial surface;
(ii) a stationary seal ring held by said holder, said seal ring defining an inside radial surface abuttingly engageable with said inside radial surface defined by said holder, said abutting engagement permitting heat transfer between said seal ring and said holder; and
(iii) an O-ring seal engageable by a circumferential peripheral surface defined by said seal ring and said inside axial surface of said holder whereby fluid flow between said seal ring and said holder is inhibited.

2. The apparatus of claim 1 wherein said O-ring is carried in a groove defined by said seal ring.

3. The apparatus of claim 2 wherein said groove is located intermediate said inside end face and an outside sealing face defined by said seal ring.

4. The apparatus of claim 2 wherein said groove is an end groove located on said inside end face of said seal ring.

5. The apparatus of claim 1 wherein said O-ring is carried in a groove defined by said holder.

6. The apparatus of claim 1 wherein said seal ring includes a plurality of recesses for receiving cooling fluid.

7. The apparatus of claim 1 wherein said inside radial face of said holder includes a plurality of recesses for receiving cooling fluid.

8. The apparatus of claim 6 wherein said recesses are radially directed slots.

9. The apparatus of claim 7 wherein said recesses are radially directed slots.

10. A cartridge seal for sealing a pump shaft of a pump, comprising:
a) a rotating section including a rotatable seal ring adapted to rotate with said pump shaft;
b) a non-rotating section sealingly engageable with non-rotating pump structure of said pump, said non-rotating section including a non-rotating seal ring held by a non-rotating seal holder;
c) an O-ring for sealing an axial, peripheral surface of said seal ring, to said holder; and
d) said holder defining an inside radial end face abuttingly engageable by an inside end face of said seal ring whereby said seal holder and said seal ring are in a heat transfer relationship.

11. The apparatus of claim 10 wherein said O-ring is carried in a groove defined in said seal ring.

12. The apparatus of claim 10 wherein said inside end face of said seal ring includes a plurality of recesses for receiving a cooling fluid.

13. The apparatus of claim 10 wherein said inside radial surface of said holder includes a plurality of recesses for receiving a cooling fluid.

14. The apparatus of claim 12 wherein said cooling fluid is lubricating oil contained in a bearing chamber defined by said pump.

15. The apparatus of claim 13 wherein said cooling fluid is lubricating oil contained in a bearing chamber forming part of said pump.

16. The apparatus of claim 10 wherein said O-ring is carried in a groove defined in said holder.
